(19) United States
(12) Patent Application Publication
(10) Pub. No.: US 2019/0314960 A1
(43) Pub. Date: Oct. 17, 2019

(54) Screwing Tool, Reversible In Rotation Direction, Encased In An Electrically Insulating Manner

(71) Applicant: Wera Werkzeuge GmbH, Wuppertal (DE)

(72) Inventor: Waldemar Popiolek, Wuppertal (DE)

(21) Appl. No.: 16/290,733

(22) Filed: Mar. 1, 2019

(30) Foreign Application Priority Data
Apr. 12, 2018 (DE) 202018101989.9

(51) Int. Cl. B25B 13/46; B25G 1/12; B25B 23/00

(52) U.S. Cl. CPC B25B 13/463; B25B 13/468; B25B 23/0007; B25G 1/125

(57) ABSTRACT

A screwing tool with an output shaft protruding in the direction of a rotation axis from a gear head having a free-run locking mechanism, which output shaft is rotatable in a stepwise manner in a rotation direction by a movement to and fro of a grip arm protruding from the gear head in radial direction, wherein the gear head, a portion of the output shaft adjoining the gear head, and the grip have an electrically insulating casing. In order to further develop such a screwing tool with regard to manufacture and advantageously with regard to use, the invention proposes that the casing has several parts and parts of the casing engage into one another at their sites adjoining one another in the manner of a labyrinth seal.

### TECHNICAL FIELD

The invention relates to a screwing tool with an output shaft protruding in the direction of a rotation axis from a gear head having a free-run locking mechanism, which output shaft is rotatable in a stepwise manner in a rotation direction by a movement to and fro of a grip arm protruding from the gear head in radial direction, wherein the gear head, a portion of the output shaft adjoining the gear head, and the grip have an electrically insulating casing.

### BACKGROUND

Screwing tools of the type designated above are previously known in the prior art under the designation “VDE ratchet”. The previously known screwing tools have a gear head in which a free-run locking mechanism, able to be changed over in direction, is arranged. A grip arm, integrally connected with the head, protrudes from the head. By moving the grip arm to and fro about a rotation axis passing through the head and extending in the direction of extent of an output shaft, the output shaft can be rotated in a stepwise manner in a constant rotation direction. The output shaft has a profile end which can be connected in a torque-proof manner to a socket which can be placed onto a hexagonal profile of a nut or of a screw. In order to enable working on live screw connections, the generic screwing tool is surrounded by a plastic casing such that with a socket placed onto the output shaft, which socket itself is encased by plastic, no metallic surface portions are able to be touched by the user.

### SUMMARY

The invention is based on the problem of further developing the generic screwing tool with regard to manufacturing and in an advantageous manner with regard to use.

The problem is solved by the invention indicated in the claims, wherein the subclaims are not only advantageous further developments of the coordinate claims, but also independent solutions to the problem.

The screwing tool according to the invention has a gear head in which a free-run locking mechanism is arranged. This is preferably a free-run locking mechanism which is reversible in rotation direction. An output shaft, functionally connected to the free-run locking mechanism, protrudes from the gear had, which output shaft is able to be driven rotationally in a stepwise manner in at least one rotation direction by a movement to and fro of a grip arm which is displaceable in radial direction by the gear head. The grip arm can be formed integrally with the gear head, which has an eye for receiving the free-run locking mechanism. The components made in particular from steel: grip arm, gear head and at least partially the output shaft, are surrounded according to the invention by an electrically insulating casing. According to the invention, the casing is formed having several parts, wherein the individual parts of the casing engage into one another in the manner of a labyrinth seal at their sites which adjoin one another. The individual parts of the casing can be: A cap applied onto the output shaft, a push-button for displacing an actuating pin within the output shaft, or a switchover button, by which the rotation direction or respectively locking direction of the free-run locking mechanism can be switched over. The labyrinth seal can preferably have at least one web, preferably an annular web, which engages into a groove, preferably an annular groove of one of the several casing parts. According to a first variant of the invention, a cap, placed onto the output shaft, is provided, which, at a separation site extending on a circular arc line around a wide-side face of the core part of the free-run locking mechanism, is connected with a casing part. The casing part is preferably an overmoulding, by which at least the gear head, but preferably also the grip arm, is injected around. The casing part can be in a single piece. However, it can also consist of several parts connected with one another, for example the casing part can also consist of half-shells connected with one another. Such half-shells can be bonded to one another. At the separation site between such half-shells, components of a labyrinth seal can also engage into one another. This casing, surrounding the head, has an opening in the shape of a circular disc, through which the core part, preferably having an exterior toothing, can be inserted into a cavity of the gear head. The overmoulding of the grip arm and of the gear head preferably takes place in an assembly state in which neither the core part nor other parts of the locking mechanism are inserted in a mounting, provided for this, of the steel base body of the screwing tool. In a subsequent assembly step, the core part can be inserted into the housing cavity of the grip head. It can be held there by means of a retaining ring. Previously, further component of the free-run locking mechanism can be inserted into the housing cavity. Thereafter, the cap is placed onto an extension of the output shaft, which has at its free end a rotary entrainment profiling, onto which the socket can be placed. A circular edge portion of the cap has an annular groove, into which an annular web of the encasement surrounding the grip head can dip. The annular web or respectively the annular groove can form steps, which in the assembled state lie tightly against one another. The annular web engages in an accurately fitting manner into the annular groove. The cap has a neck which lies closely against an extension of the core part. At the free end of the neck, the cap is connected with the output shaft by a retaining ring. However, differently configured holding connections can also be provided, by which the cap, which is made from plastic, can be fastened to the output shaft. In the preferred solution, the output shaft has an annular groove in which a retaining ring lies. In a further development, provision is made that the plastic casing of the gear head forms an annular web, which engages into an annular groove of an annular wall. This annular wall embraces an annular chamber. The wall lies opposite the neck, so that the annular chamber extends between the wall and the neck of the cap. In this annular chamber a portion of a socket, surrounded by a plastic insulation, can be inserted. The profile portion for engagement in a counter-profile portion of the socket can have a detent ball, which can be displaced through an axial displacement of an actuating pin from a locking position into a releasing position. In the locking position, the detent ball holds the socket in a constraining position at the output shaft. Through an axial displacement of the actuating pin, lying in an axial bore of the output shaft, the detent ball is brought into a releasing position, in which socket can be withdrawn from the output shaft.

A second aspect of the invention relates to a push-button, which sits at an end of the actuating pin. For this, the push-button preferably has a cavity in which a free end of the actuating pin extends. A form-fitting connection can be provided between the push-button and the actuating pin. The push-button can be injected onto the free end of the actuating pin. Material of the push-button, which consists of plastic, can be entered into an annular groove of the actuating pin. To receive the push-button, the plastic casing of the gear head has on its side pointing away from the output shaft a cup-shaped cavity. The cup-shaped cavity is surrounded by an edge which is closed circumferentially. The base of the cup-shaped cavity has a through-opening for the actuating pin to pass through. Preferably, the through-opening has an opening width such that an extension which is arranged on the underside of the push-button projects into the through-opening. The extension surrounds the end of the actuating pin projecting into the cavity. The edge of the through-opening forms an annular collar projecting into the cup-shaped cavity. This annular collar engages with axial play into an annular groove on the underside of the push-button. An external wall of the push-button slides on an inwardly projecting wall of the cup-shaped cavity. On the side lying opposite the annular groove, the push-button has a touch surface. This touch surface can be actuated in order to displace the push-button into the cavity. The extension rests on a compression spring, which rests on the base of a depression of the core part. This compression spring is tensioned when the push-button is displaced into the cavity by pressure onto the touch surface. Accompanying this axial displacement of the push-button, the actuating pin is displaced from the locking position into the releasing position. The cup-shaped cavity has a face edge which surrounds the touch surface, which is a face surface of the push-button. In the non-acted-upon position, in which the actuating pin assumes its locking position, the slightly outwardly curved touch surface projects over the face edge of the cup-shaped opening, at least partially. Through a pressure onto the touch surface, the push-button is displaced deeply into the cavity such that the touch surface lies entirely beneath the edge of the cup-shaped cavity. The detent ball can only enter into its releasing position when the touch surface is displaced into the cavity. The touch surface, projecting out over the edge in the normal state, forms to a certain extent a buffer or damper owing to the spring mounting of the push-button via the compression spring, which buffer or damper protects the edge of the cup-shaped cavity when the tool is acted upon by impact for example on falling on the side pointing away from the output shaft.

A further version of the invention relates to a switchover button. The free-run locking mechanism, reversible in rotation direction, preferably has a changeover switch made of steel, which projects out from the side of the steel base body which is pointing away from the output shaft. A switchover button, made from plastic, is placed onto this changeover switch. Preferably, form-fitting means are provided, by which the switchover button is connected in axial direction, preferably also in rotational direction, with the changeover switch. The switchover button has an extension which projects into a through-opening of the grip casing. The changeover switch also projects into this through-opening. From the edge of the through-opening an annular collar extends into a depression in which the switchover button is arranged. An annular web forms, which projects into an annular groove of the switchover button. A circumferential wall of the switchover button lies against a wall of the depression. A face edge of the depression runs above a face side of the switchover button. An actuating arm, protruding from the switchover button, is situated in a free area of the edge of the depression and overlaps an edge web.

### BRIEF DESCRIPTION OF THE DRAWINGS

An example embodiment of the invention is explained below with the aid of enclosed drawings. There are shown:

FIG. 1 a perspective illustration of a screwing tool encased with plastic,

FIG. 2 the cut-out in FIG. 1 on an enlarged scale,

FIG. 3 a side view onto the tool illustrated in FIG. 1,

FIG. 4 the section according to line IV-IV in FIG. 3,

FIG. 5 the section according to line V-V in FIG. 1 and

FIG. 6 the section according to line VI-VI in FIG. 5.

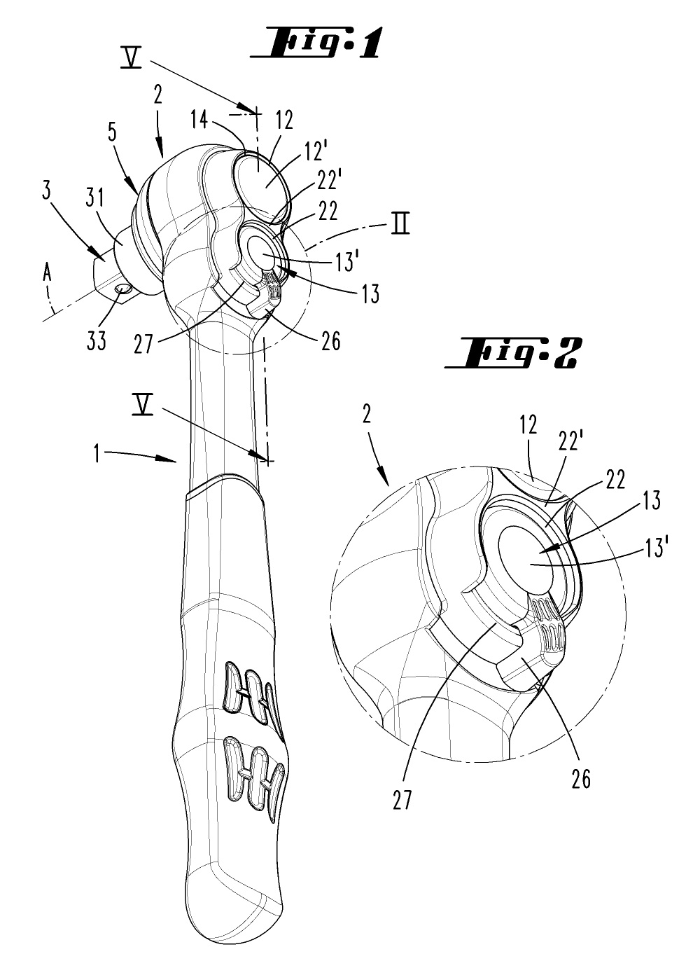

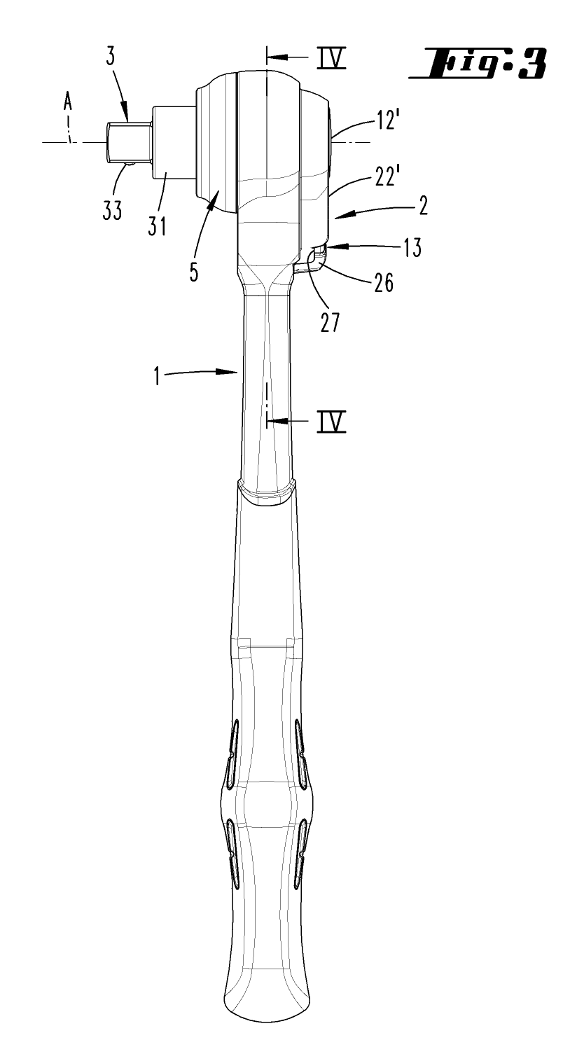

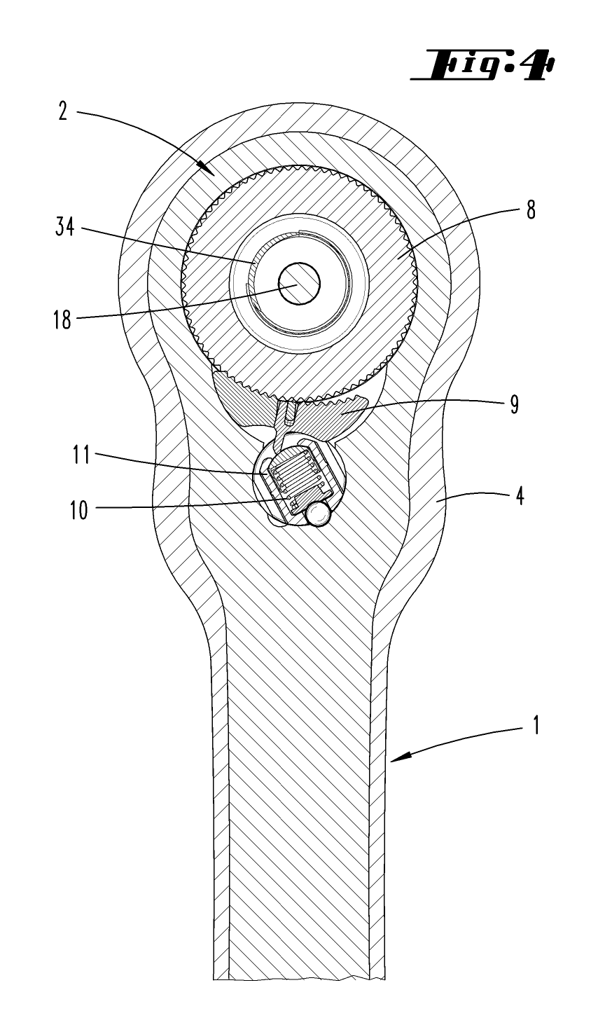

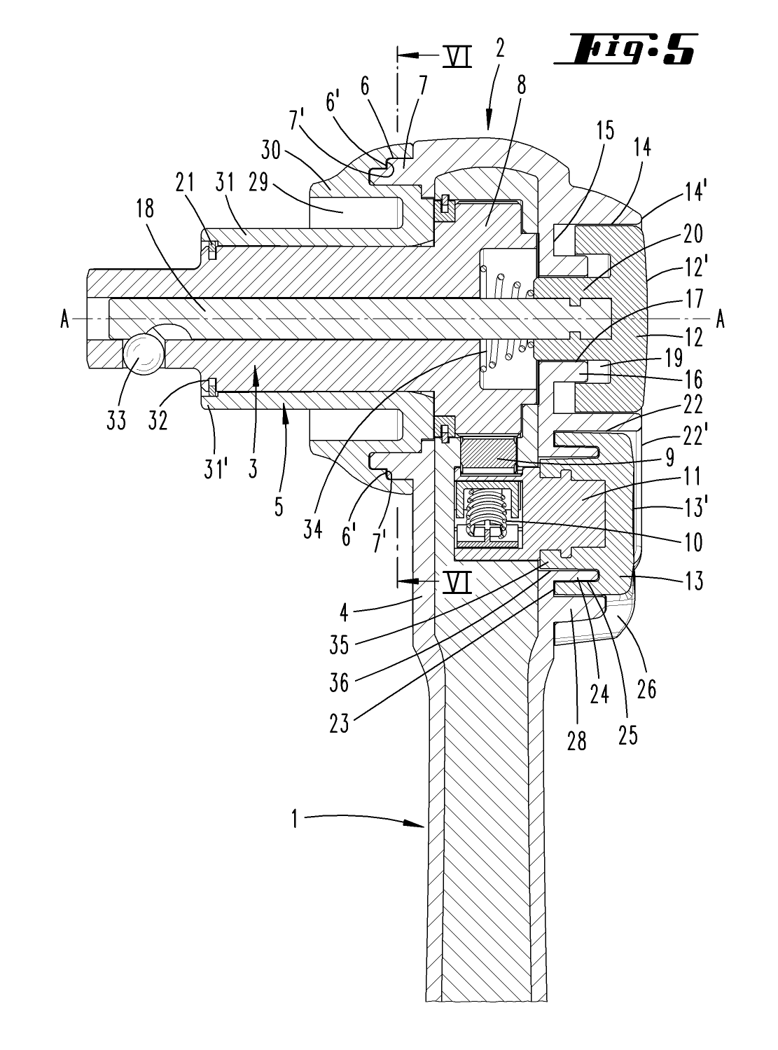

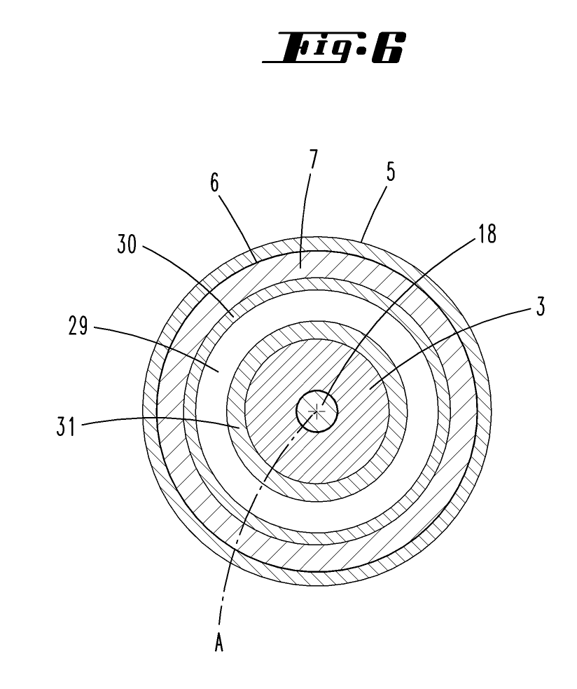

### DETAILED DESCRIPTION

The tool illustrated in the drawings has a grip arm 1 made from steel, onto which a gear head 2 is integrally formed. The gear head 2 has an eye-shaped opening for receiving a toothed core part 8. The toothed core part 8 is fixed with respect to a rotation axis A—by means of a retaining ring in the housing cavity of the gear head 2.

In the gear cavity, furthermore, a locking piece 9, having several parts in the example embodiment, is provided, which can be displaced by means of a changeover switch 11. Accompanying this displacement, the free-run direction or respectively the locking direction changes of a free-run locking mechanism which is formed by the core part 8, the locking piece 9 and the changeover switch 11. A spring element 10 of the changeover switch 11 acts upon a rearward extension of the locking piece 9 such that a toothing arranged on the side of the locking piece 9 opposite the extension engages into an exterior toothing of the locking piece 9. For switching over of the changeover switch 11, a portion of the changeover switch 11 projecting out from the housing cavity must be rotated. The rotation axis of the changeover switch 11 runs parallel to a rotation axis A, about which the output shaft 3 can be rotated.

The output shaft 3 has an axial cavity in which an actuating pin 18 is situated. At its first end, the actuating pin has a recess, which cooperates with a detent ball 33. By its second end, the actuating pin 18 projects out from the gear cavity. The second end lies adjacent to an end of the changeover switch 11 projecting out from the gear cavity. By an impingement of the actuating pin 18 in axial direction against the restoring force of a compression spring 34, which rests on the base of a depression of the core part 8, the actuating pin 18 can be brought from a locking position into a releasing position, in which the detent ball 33 can draw away from a radial forward position—in relation to the rotation axis A—into a position displaced inward in the output shaft 3.

The grip arm 1 and the gear head 2 are surrounded by a plastic casing 4. The plastic casing 4 is injected onto the grip arm 1 and on the gear head 2. The plastic casing 4 has, in particular, three openings. A first opening is situated on the side of the output shaft 3 and has an opening width which is preferably sufficiently large that the core part 8 can be mounted through the opening.

A second opening lies diametrically opposite the first opening and is formed by a through-opening 17 through which the second end of the actuating pin 18 projects.

The third opening 11 forms a through-opening 36 through which the changeover switch 11 passes.

All three openings are closed in an electrically insulated manner by plastic parts 5, 12, 13, wherein respectively annular webs 7, 16, 24 engage in annular grooves 6, 19. 25.

The plastic part 5 forms a cap which is placed onto the output shaft 3. The cap forms a neck 31, which is placed lying closely onto a portion, which is round in cross-section, of the output shaft 3, so that the output shaft 3 can move rotatably in the cap 4. A profiled end portion of the output shaft 3, which also has the detent ball 33, projects out from the neck 31 of the cap 5.

The neck 31 has a free end 31′, which has a step which is overlapped by a retaining ring 21, which lies in an annular groove 32 of the output shaft 3.

The side of the cap 5 lying opposite the free end 31′ forms an annular chamber 29 for receiving a portion of a socket which is encased with plastic. The socket, which is not illustrated in the drawings, has a placement profile which can be placed onto the free rectangular profile end of the output shaft. An engaging with the socket takes place by means of the detent ball 33. The outer wall of the socket is surrounded by a plastic overmoulding.

The annular chamber 28 is delimited toward the radial exterior by a wall 30, which forms an annular groove 6 on its side pointing away from the free end 31′, into which annular groove an annular web 7 of the plastic casing 4 engages. The annular web 7 has steps 7′, which lie in close abutment against steps 6′ of the annular groove 6.

The push-button 12 has a touch surface 12′ and, on its side lying opposite the touch surface 12′, an extension 20 which has an axial cavity in which an end of the actuating pin 18 is inserted in a form-fitting manner. By plastic material entering into an annular groove of the actuating pin 18, the actuating pin 18 is connected with the push-button 12 in a form-fitting manner.

The extension 20 has a wall pointing radially outwards, which lies against a radially inwardly pointing wall of an annular collar 16. The annular collar 16 surrounds the through-opening 17 which extends in the base 15 of a cup-shaped depression 14. In the cup-shaped depression 14 the push-button 12 is mounted slidingly in axial direction. The extension 20 of the push-button 12 rests on an end of the cone-shaped compression spring 34, which holds the actuating pin 18 in its locking position.

The annular collar 16 engages with axial movement play into the annular groove 19.

In order to bring the detent ball 33 into a releasing position, the touch surface 12′ must be acted upon by force against the restoring force of the compression spring 34. Proceeding from a locking position, in which at least a central portion of the touch surface 12′, but preferably the entire touch surface 12′, runs above an edge 14′ of the cup-shaped cavity 14, the push-button 12, accompanied with a tensioning of the spring 34, is displaced into the cup-shaped cavity 14. The touch surface 12′ must be displaced entirely into the cup-shaped cavity 14, in order to make it possible that the detent ball 33 can be displaced into its releasing position.

A switchover button 13 is inserted in a depression 22, which extends adjacent to the cup-shaped cavity 14. The depression 22 has a radially inwardly pointing wall, against which a radially outwardly pointing wall of the switchover button 13—arranged rotatably in the depression 22—lies. A face surface 13′ of the switchover button 13 lies beneath the edge 22′ of the depression.

On its side lying opposite the face side 13′ the switchover button 13 has an extension 35, in which a portion of the changeover switch 11 is inserted in a torque-proof and axially fixed manner. The extension 35 engages into the through-opening 36.

From the edge of the through-opening 36 an annular collar 24 extends into the depression 22, which engages into an annular groove 25 of the rear side of the switchover button 13.

An actuating arm 26 protruding radially from the switchover button 13 can be pivoted to and fro between two switching positions. Accompanying the pivoting to and fro of the actuating arm 26, the position of the locking piece 9 changes, so that the locking direction or respectively rotation direction of the free-run locking mechanism changes over.

The actuating arm 26 engages through the wall of the bearing depression 22 of the switchover button 13, for which a free area 27 is provided. The actuating arm 26 also overlaps here an edge web 28 of the depression 22.

It is regarded as being advantageous that all the openings of the plastic casing 4 are closed respectively by cap-shaped plastic parts 5, 12, 13, wherein the cap-shaped plastic parts 5, 12, 13 respectively have annular grooves 6, 19, 25, into which annular webs 7, 16, 24 engage in an electrically insulating manner, extending a spark gap.

The above embodiments serve to explain the inventions included as a whole by the application, which further develop the prior art at least through the following feature combinations respectively also independently, wherein two, several or all of these feature combinations can also be combined, namely:

A screwing tool, which is characterized in that the casing 4, 5 has several parts and parts of the casing 4, 5 at their sites adjoining one another engage into one another in the manner of a labyrinth seal 6, 7; 16, 19; 24. 25.

A screwing tool, which is characterized in that a plastic cap 5 placed onto the output shaft 3 is connected with a casing part 4 surrounding the gear head 2 at a separation site extending on a wide-side face of a core part 8 of the free-run locking mechanism 8, 9, 10, wherein an annular web 7 engages into an annular groove 6.

A screwing tool, which is characterized in that the annular web 7 is formed on the casing part 4 surrounding the gear head 2.

A screwing tool, which is characterized in that the annular web 7, extending in particular on a circular arc line, and the annular groove 6, form steps 7′, 6′, which lie against each other, touching one another.

A screwing tool, which is characterized in that the annular web 7 engages into a wall 30 of the cap 5, which surrounds an annular chamber 29 around a neck 31 of the cap 5.

A screwing tool, which is characterized in that the cap 5 is fastened to the output shaft 3 by means of a holding connection 21.

A screwing tool, which is characterized in that a neck 31, lying closely against the output shaft 3, is fastened on the output shaft 3 with a retaining ring 21, wherein the retaining ring 21 engages in particular into a circumferential groove 32 of the output shaft 3.

A screwing tool, which is characterized in that a push-button 12, lying opposite the output shaft 3, consists of plastic and lies in a cup-shaped cavity 14, which has a through-opening 17 for an actuating pin 18 made of metal, wherein a base 15 of the cavity 14 has an annular collar 16 which is raised in the direction of the opening of the cavity 14, which annular collar engages into an annular groove 19 of the push-button 12.

A screwing tool, which is characterized in that an inwardly projecting wall of the annular collar 16 forms a sliding guide for an extension 20 of the push-button 12 projecting into the through-opening 17.

A screwing tool, which is characterized in that the extension 20 rests on a first end of a compression spring 34 which rests by a second end on the base of a recess of the core part 8.

A screwing tool, which is characterized in that at least a central portion of a face surface 12′ of the push-button 12 projects slightly over an edge 14′ of the cup-shaped cavity 14 and through axial pressure is able to be brought into an actuating position, in which the touch surface 12′ is arranged within the cup-shaped cavity 14 below the edge 14′,

A screwing tool, which is characterized in that a switchover button 13, consisting of plastic, sits rotatably in a depression 22, from the base 23 of which an annular collar 24 originates, which engages into an annular groove 25 of the switchover button 13.

A screwing tool, which is characterized in that the switchover button 13 is connected in a torque-proof manner with a changeover switch 11, by which the free-run/locking direction of the free-run locking mechanism 8, 9, 10 is able to be reversed.

A screwing tool, which is characterized in that an edge 22′ of the depression 22 runs above a face surface 13′ of the switchover button, so that the face surface 13′ is arranged within the depression 22.

A screwing tool, which is characterized by an actuating arm 26, protruding from a central portion of the switchover button 13, which actuating arm is arranged in a free area 27 of an edge web 28.

A screwing tool, which is characterized in that the free-run locking mechanism has a locking piece 9 able to be switched over by a changeover switch 11 and provided with a toothing, which toothing engages into an exterior toothing of a core part 8, which is in particular divided into two, wherein the locking piece 9 is acted upon by force by a compression spring 10, arranged in a cavity of the changeover switch 11, in the direction of the exterior toothing of the core part 8.

A screwing tool, which is characterized in that the plastic casing 4 of the grip arm 1, which consists of steel, and of the gear head 2, which consists of steel, is a plastic overmoulding.

A screwing tool, which is characterized in that the cap 5, which sits on the output shaft 3 which is made from steel, is a plastic shaped part, in particular an injection moulded part.

All the disclosed features are essential to the invention. Herewith also the disclosure content of the associated/enclosed priority documents is also included in full into the disclosure of the application, also for the purpose of including features of these documents into claims of the present application. The subclaims characterize, also without the features of a claim referred to, with their features, independent inventive further developments of the prior art, in particular in order to carry out divisional applications on the basis of these claims. The invention indicated in each claim can additionally have one or more of the features in the above description, in particular provided with reference numbers and/or indicated in the list of reference numbers. The invention also relates to forms of embodiment in which individual ones of the features named in the above description are not realized, in particular in so far as they are recognizably unnecessary for the respective purpose of use or can be replaced by other means which have the same technical effect.

1. A screwing tool with an output shaft protruding in the direction of a rotation axis from a gear head having a free-run locking mechanism, which output shaft is rotatable in a stepwise manner in a rotation direction by a movement to and fro of a grip arm protruding from the gear head in radial direction, wherein the gear head, a portion of the output shaft adjoining the gear head, and the grip have an electrically insulating casing wherein the casing has several parts and parts of the casing engage into one another at their sites adjoining one another in the manner of a labyrinth seal.

2. The screwing tool according to claim 1, wherein a plastic cap, placed onto the output shaft, is connected at a separation site extending on a wide-side face of a core part of the free-run locking mechanism with a casing part surrounding the gear head, wherein an annular web engages into an annular groove.

3. The screwing tool according to claim 1, wherein the annular web is formed on the casing part surrounding the gear head.

4. The screwing tool according to claim 1, wherein the annular web, extending in particular on a circular arc line, and the annular groove form steps, which lie against each other, touching one another.

5. The screwing tool according to claim 1, wherein the annular web engages into a wall of the cap, which surrounds an annular chamber around a neck of the cap.

6. The screwing tool according to claim 1, wherein the cap is fastened to the output shaft by means of a holding connection.

7. The screwing tool according to claim 1, wherein a neck, lying closely against the output shaft, is fastened to the output shaft with a retaining ring, wherein the retaining ring engages in particular into a circumferential groove of the output shaft.

8. A screwing tool with an output shaft protruding in the direction of a rotation axis from a gear head having a free-run locking mechanism, which output shaft is rotatable in a stepwise manner in a rotation direction by a movement to and fro of a grip arm protruding from the gear head in radial direction, wherein the gear head, a portion of the output shaft adjoining the gear head, and the grip have an electrically insulating casing, wherein a push-button lying opposite the output shaft consists of plastic and lies in a cup-like cavity which has a through-opening for an actuating pin made of metal, wherein a base of the cavity has an annular collar, raised in the direction of the opening of the cavity, which annular collar engages into an annular groove of the push-button.

9. The screwing tool according to claim 8, wherein an inwardly projecting wall of the annular collar forms a sliding guide for an extension of the push-button projecting into the through-opening.

10. The screwing tool according to claim 8, wherein the extension rests on a first end of a compression spring, which rests by a second end on the base of a recess of the core part.

11. The screwing tool according to claim 8, wherein at least a central portion of a face surface of the push-button projects slightly over an edge of the cup-shaped cavity and is able to be brought by axial pressure into an actuating position, in which the touch surface is arranged within the cup-shaped cavity beneath the edge.

12. A screwing tool with an output shaft protruding in the direction of a rotation axis from a gear head having a free-run locking mechanism, which output shaft is rotatable in a stepwise manner in a rotation direction by a movement to and fro of a grip arm protruding in radial direction from the gear head, wherein the gear head, a portion of the output shaft adjoining the gear head, and the grip have an electrically insulating casing, wherein a switchover button, consisting of plastic, sits rotatably in a depression, from the base of which an annular collar originates, which engages into an annular groove of the switchover button.

13. The screwing tool according to claim 12, wherein the switchover button is connected in a torque-proof manner with a changeover switch, by which the free-run/locking direction of the free-run locking mechanism is reversible.

14. The screwing tool according to claim 12, wherein an edge of the depression runs above a face surface of the switchover button, so that the face surface is arranged within the depression.

15. The screwing tool according to claim 12, characterized by an actuating arm, protruding from a central portion of the switchover button, which actuating arm is arranged in a free area of an edge web.

16. The screwing tool according to claim 12, wherein the free-run locking mechanism has a locking piece, able to be switched over by a changeover switches and provided with a toothing, which toothing engages into an exterior toothing of a core part which in particular is divided in two, wherein the locking piece is acted upon by force in the direction of the exterior toothing of the core part by a compression spring arranged in cavity of the changeover switch.

17. The screwing tool according to claim 12, wherein the plastic casing of the grip arm, consisting of steel, and of the gear head, consisting of steel, is a plastic overmoulding.

18. The screwing tool according to claim 12, wherein the cap, which sits on the output shaft made from steel, is a plastic shaped part, in particular an injection-moulded part.

19. (canceled)

20. The screwing tool according to claim 2, wherein the annular web is formed on the casing part surrounding the gear head.

21. The screwing tool according to claim 9 wherein the extension rests on a first end of a compression spring, which rests by a second end on the base of a recess of the core part.
